(19) United States
(12) Patent Application Publication
(10) Pub. No.: US 2006/0129440 A1
(43) Pub. Date: Jun. 15, 2006

(54) Device and method for producing a processing tool

(75) Inventors: Franz Frauenhoffer, Bondorf (DE); Eberhard Gloger, Nufringen (DE); Johannes Rudnitzki, Weinstadt (DE); Gerd Schlaich, Rutesheim (DE)

Correspondence Address: DAVIDSON, DAVIDSON & KAPPEL, LLC, 485 SEVENTH AVENUE, 14TH FLOOR, NEW YORK, NY, 10018, US

(73) Assignee: DaimlerChrysler AG, Stuttgart (DE)

(21) Appl. No.: 10/534,688

(22) PCT Filed: Sep. 13, 2003
(86) PCT No.: PCT/EP03/10192

§ 371 Date: Nov. 14, 2005

(30) Foreign Application Priority Data
Nov. 15, 2002 (DE) 102532982

(51) Int. Cl. G05B 19/418

(52) U.S. Cl. 705/8

(57) ABSTRACT

In an exemplary embodiment of the present invention, a method for producing a processing tool is provided. In the method, the processing tool processes at least one electronic workflow comprising working steps on a first data processing system, and a second data processing system is used for producing the processing tool. According to the exemplary embodiment of the present invention, the method comprises the steps of: producing an information model for the workflow, the step of producing being carried out by adapting a prescribed information model and, during the adaptation, executing an operation for adding deleting or changing data object types and relations between data object types, producing a specification of the workflow by using data object types and relations of the adapted information model, adapting a standard processing tool comprising a prescribed data storage system to the adapted information model, adapting the prescribed data storage system to the adapted information model, and configuring the adapted standard processing tool as a function of the specification. In addition, the present invention provides a device, which can comprise a computer having an internal memory, and a computer program product comprising, for example program modules, for producing a processing tool.

The invention relates to a device and a method for producing a processing tool which processes an electronic workflow comprising working steps.

A procedure and a software tool by the name of ARIS are disclosed in August-Wilhelm Scheer: “ARIS—vom Geschäftsprozess zum Anwendungssystem” [ARIS—from the business process to the application system], Springer-Verlag, 4th edition, 2002. It is described how ARIS is used to model a business process. How an application system which processes this business process is produced is outlined.

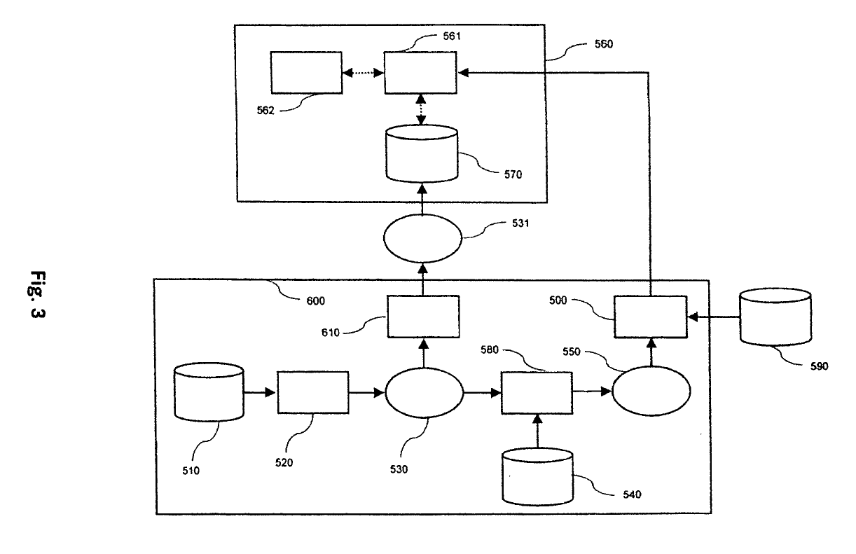

A model of a business process is created, cf. for example A.-W. Sheer, FIG. 24. For this, process elements of various types are used. It is possible here to individualize reference modules, for example for business processes in production, acquisition, sales (A.-W. Scheer, FIG. 50). The business process is processed with the aid of a system for flow control. Systems of this type are often referred to as “Workflow Systems” (section D.III). In section D.IV.2.2 et seq., business objects with standardized interfaces and access methods are presented.

The ARIS software tool (“framework”) has an architecture with the following four layers (cf. section D.V.2.1):
the layer of process formation, which comprises tools to model a business process. A user can produce process, function and data models, organigrams and diagrams for authorizations,
the layer of process planning and control, which comprises tools with which the processing of a business process is controlled and monitored, for example the “ARIS Process Control Interface” and tools for cost calculations which are related to working steps and activities (“ARIS Activity-Based Costing”),
the layer of workflow management for the processing of workflows and with interfaces to workflow management systems,
the layer of business objects (“ARIS Business Objects”). Examples of business objects are customer, order, work schedule, working operation, supplier.

Under the designation “mySAP Supply Chain Management” (mySAP SCM), SAP offers a software environment for the interlinking, planning, coordination and execution of a logistics chain for a manufacturing company. The software environment, which is presented at http://www.sap-ag.de/germany/solutions/scm/ (visited on Mar. 13, 2002), makes it possible inter alia to adapt a logistical infrastructure to changes in the market, for example the introduction of new products or new customer segments (“supply chain design”). Each phase of the logistics process, from the price calculation to the delivery to the customer, is monitored, and notifications are sent in the case of deviations from the plan (“supply chain event management”). Purchasing on the Internet is integrated, including rule-based procurement, automated replenishment and support of a number of suppliers. Logistics chains are managed in all phases of the production process, even beyond company boundaries.

The software environment mySAP E-Procurement supports both the business-to-business procurement for manufacturing material and for indirect material. mySAP E-Procurement (http://www.sap-ag.de/germany/solutions/e-procurement/, visited on Mar. 13, 2002) makes possible the strategic procurement of production material, such as raw materials and auxiliary materials, spare parts (for example tachometers) or other goods, and supports the purchasing of indirect, non-manufacturing-bound goods and services, including the operating resources and auxiliaries, stationery, machine parts, housekeeping requisites and repairs.

Both the procedure and tool disclosed in A.-W. Scheer, loc. cit., under the designation ARIS, and the SAP modules described above have fixed data models, for example for business objects, transactions, changes in the type of performance. It is necessary that the user adapts his business processes and his processing tool to these specifications, for example those of the data model. An adaptation (“customizing”), for example of an SAP model, often comes close to an individual solution for a specific business process.

In U.S. Pat. No. 5,774,661, a method and a device are disclosed to control the processing of workflows by means of a graphical user interface, without individual programming being necessary. A central network computer (“workflow server computer”) comprises a data store for data objects (“object repository”) and a first interpreter for logical rules (“rule engine”). The interpreter evaluates complex logical expressions, in order for example to decide on the passing on of documents in dependence on variables. The central network computer is connected to at least one network user computer (“client computer”). On the latter there runs a graphical user interface, with which electronic workflows can be produced (“workflow builder”), a rule producer (“rule builder”) and a further rule interpreter. By these workflows, data objects are directed through a data network (“routing”), to be precise in dependence on user inputs and on actions of the rule interpreter. The descriptive language and the operating principle of the rule interpreter are described in detail. A script executor (“script handler”) converts the results of the rule interpreter into commands for external application programs, for example for the data output or the dispatch of e-mails.

According to the method disclosed in U.S. Pat. No. 5,774,661, each workflow must be graphically generated afresh with business rules. Even when different companies have defined different workflows for the same application category, for example for the procurement of goods and services, and require processing tools for these workflows, a workflow has to be made available to the computer each time afresh, from scratch, with the graphical user interface and the “workflow builder”.

The invention is based on the object of providing a device and a method by which a facility for processing any desired electronic workflow on a data processing system is produced quickly and efficiently.

The object is achieved by a device as claimed in claim 1, a method as claimed in claim 9 and a computer program product as claimed in claim 14 or claim 15. Advantageous refinements are specified in the subclaims.

The processing tool is adaptable to any desired electronic workflow with working steps. As a result, it is not necessary to restrict the formation of the workflow, for example because it must match a specific information model with specific data object types and relations between them or must be compatible with a prescribed standard workflow. The invention additionally dispenses with the need to implement an individual solution “from scratch” for a workflow which is not compatible with a standard workflow or a standard workflow tool, which is time-consuming and prone to errors.

According to the invention, the information model is adapted to the workflow, instead of having to adapt the workflow to the information model. Because the information model used is tailored to the electronic workflow by a prescribed standard information model being adapted by adding, deleting or changing data objects, work is saved in comparison with the procedure of producing an information model “from scratch”.

The invention makes it possible to integrate already existing legacy systems logically and not only on a data level and to reuse the data and information stored in them. Furthermore, legacy systems can be used in particular as sources of data. This reuse dispenses with the need to adapt the data and information to a new processing tool, involving great expenditure and a high risk of errors. Likewise, it is not necessary to modify legacy systems or even take them out of productive use or else adapt the processing tool to a legacy system.

An exemplary embodiment of the invention is described in more detail below on the basis of the accompanying drawings, in which:

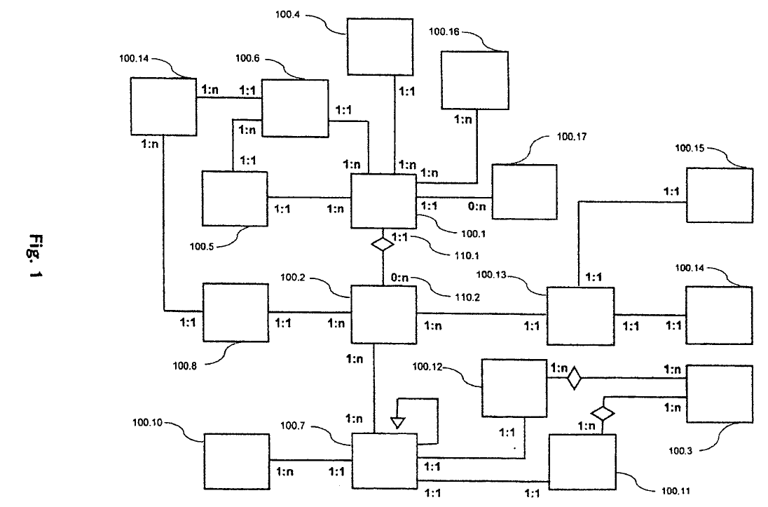

FIG. 1 shows an example of a firm-specific information model with the data object type “extent of procurement”;

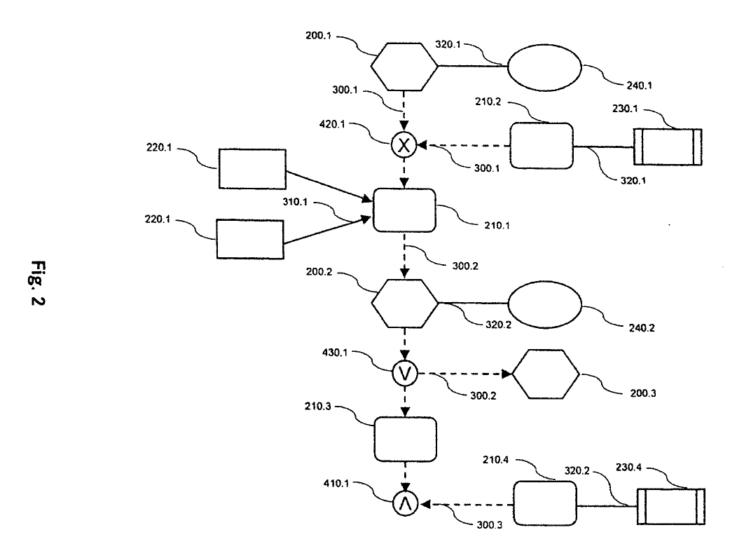

FIG. 2 shows a detail from an electronic specification of a workflow;

FIG. 3 shows an architecture of the device, given by way of example.

The method according to the invention is explained by the example of the supplier management of a manufacturing company, for example a car manufacturer. The processing tool 560, produced according to the invention, is called supplier manager for this example. It comprises a data storage system 570, an application layer 561 with processing logic and a user interface layer 562 with a user interface. However, the method according to the invention can also be applied to any other application area in which a workflow is to be electronically processed and a processing tool is required for this.

Supplier management refers to a set of activities which are executed with the aim that a company obtains goods and services from external and/or internal suppliers at the appropriate cost and time, has its purchasing costs “under control” and copes with variants and customer complaints. Each company that manufactures technical products must operate supplier management in a suitable form along its value creation chain to be able to survive on the market.

Typically, supplier management comprises selection of at least one supplier and implementation and monitoring of the procurement of a prescribed extent of procurement from the selected supplier. Supplier management preferably includes individual workflows, for example for order placement, the handling of changes and cost reduction. Supplier management often covers a number of companies, a number of sites, a number of functions and a number of disciplines.

Supplier management preferably also comprises operative purchasing, for example with invitation to tender, the obtainment of offers, decision-making on at least one offer, contract award and monitoring of delivery. Purchasing auctions on the Internet may constitute part of supplier management. The supplier management of a manufacturing company is preferably restricted to the direct suppliers of the manufacturing company. That these direct suppliers have suppliers themselves, which from the viewpoint of the manufacturing company are subcontracted suppliers, is not taken into consideration by the manufacturing company in its own supplier management.

Supplier management is determined by a business process which specifies individual workflows of the supplier management. Such a workflow comprises working steps which in each case have at least one input and at least one output. Many manufacturing companies have defined firm-specific business processes, for example for supplier management. They have often invested considerable expenditure for this definition, for example for coordination between organizational units involved. A company often becomes differentiated from competitors by good business processes.

One advantage of the invention is that the method provides a business manager for individual or all the work processes of this firm-specific business process. The supplier manager is tailored with little expenditure to the workflows to be processed of the business process, instead of the business process that is to be processed having to be tailored to a specific procedure or to a specific information model, data model or software product. A powerful supplier manager standardizes the business processes, for example the purchasing processes. A binding, comprehensible and ideally optimized business process for the supplier management, which is linked with the product creation process, is supported and partly automated. Even non-optimized business processes can be supported by the supplier manager. The supplier manager makes the business process transparent and allows prompt controlling intervention in the business process, for example if there is the risk of deadlines not being met. This allows a company to save costs and to keep to cost targets and deadlines reliably and to cope with variants.

Apart from being used for the “actual” supplier management—the supplier manager produced can be additionally used for the following application purposes:
for the prediction of costs or deadlines
as a data analysis tool (“data warehouse”) for subtasks of supplier management—thanks to the generic information model and the integration in the IT environment, the data required for meaningful statistical evaluations are available.
for simulation—the supplier manager processes a fictitious extent of procurement on a trial basis, the extent of procurement running through the business process or individual workflows. Weak points in this business process or workflow can be identified.
for the comparison of alternatives during the specification or the execution of a workflow. In order to compare two alternatives of the workflow, two supplier managers are produced by the method according to the invention. Both of the two supplier managers are compared with each other. In particular, an average number
   of generated screen forms,
   of required screen interactions,
   of databank reading accesses
   and/or of databank writing accesses
   are compared.
as an early warning system—which process steps can lead to delays, which steps belong to the “critical path”)?
for the instruction and training of employees.

The supplier manager produced according to the invention is a software system which can run on a first data processing system. The supplier manager includes a single workflow or a set of electronic workflows. An aim is prescribed, for example selection of suppliers for a prescribed extent of procurement. The business process specifies the workflows. After selection of some of these workflows, the selected workflow or workflows are run through. This typically involves, inter alia, running through a sequence of screen forms in which purchasers and employees of suppliers enter inputs, for example a supply deadline for an inquiry or a price of an offer. Such a form preferably comprises at least one input field, a field for the display of data and a navigation element. An electronic document is repeatedly generated from user inputs in a screen form.

In a relatively large company, a number of extents of procurement, and with them a number of “instances” of workflows, are processed in parallel, for example an extent of procurement for the “driver's seat car type A”, one for the “headlamp car type B” and one for the “shell car type C”. The instances may be at different stages of processing or degrees of completion.

The invention makes it possible to efficiently produce a supplier manager which processes a complete business process. This business process is modeled by the specifications of a number of workflows. Each workflow is preferably characterized by a data object, which is for example enriched, refined or worked on in some other way by the processing of the workflow. For example, attributes of the characterizing data object are allocated values or relations between the characterizing data object and further data objects are produced. The workflow additionally makes reference to other data objects, for example in that these other data objects are read in or changed in a writing mode or linked with one another by relations.

Preferably, a number of workflows of a business process are not linked with one another directly or extended beyond the extent envisaged. Rather, two workflows are connected to each other via the common database of the supplier manager, the data model 531 of which was produced by using the firm-specific information model 530. Two workflows automatically interact with each other in particular by the first workflow inserting data objects into the data storage system 570 or changing existing data objects and the second workflow reading in some of these data objects. Conversely, the second workflow may add or change data objects which the first one reads in. This decoupling allows the workflows to be changed independently of one another, and the supplier manager is of a modular construction.

A preferred embodiment of the method according to the invention for producing a firm-specific supplier manager comprises the following steps:
A firm-specific information model 530 with types of data objects is produced by a standard information model for the supplier management being adapted as required to the workflow to be processed.
This firm-specific information model 530 is used to produce a specific data model 531 as a physical data storage scheme of the data storage system 570. If, for example, a relational databank is used for the data storage, a relational databank scheme is produced as a data model. On the basis of this data model 531, a data storage system 570 of the processing tool 560 is produced.
From a library 540 with electronic standard workflows, at least one of these standard workflows is selected. Each electronic standard workflow is assigned a standard processing tool. A standard processing tool of this type is a processing module which can be processed by the data processing system and has reading access and/or writing access to the data storage system 570.
A specification 550 of a generally firm-specific workflow with working steps is produced. For the specification 550, data object types of the firm-specific information model 530 and relations between them are used. For the production of the specification 550, the selected standard workflow is modified if required.
Calculating or checking rules which relate to data objects and/or working steps and can be automatically executed are produced.
The standard processing tool of the selected standard workflow is configured with the aid of the specification 550 of the workflow to be processed.
The processing module is integrated to form the supplier manager 560 and inserted into a prescribed IT environment.

The steps are described in detail below.

Preferably, commercial software tools are used in an inventive way, in order in particular
to produce the specific information model 530 and the data model 531,
to create the specification 550 of the workflow,
to produce calculating and checking rules,
to produce the electronic workflows,
to realize interfaces to legacy systems of the IT environment
and to produce a source program in a suitable programming language, for example Java.

The method according to the invention makes it possible to produce a supplier manager for a prescribed and generally firm-specific workflow quickly and efficiently. If the workflow is changed or extended later, the method can advantageously be executed anew, in order to produce a new supplier manager for the changed business process. It is not necessary to adapt the supplier manager manually. This avoids the risk of the changed supplier manager no longer being compatible with the new workflow.

According to the invention, a specific information model 530 is used for the specification 550 of the workflow. A model is a simplified and inevitably incomplete snapshot of reality. The model contains the properties and dependencies of reality that are required for achieving a specific task. The term “information” is used to designate the abstract meaningful content (the “semantics”) of a statement, description, instruction, message or communication. In order to represent and store information, for example in a computer, data are used. An information model is a simplification of reality, by which information and facts for the processing of at least one task are structured. A data model describes how the data structured according to an information model are physically stored, for example in a file or a databank. A relational databank scheme and an “entity-relationship diagram” are two examples of data models of this type.

The supplier manager 560 produced according to the invention comprises or has reading and writing access to a data storage system 570, for example a databank with data objects. The data objects represent physical or commercial business objects which are used for the supplier management or play a role in it.

The databank is preferably produced by using a data model 531 in such a way that the data objects of the databank and the relations among these data objects are compatible with the data model.

The firm-specific information model 530 is preferably produced by a generic information model being tailored to the circumstances and requirements of the manufacturing company (“information model customizing”). Both information models comprise types of data objects and relations between these data object types. The generic information model applies for example to the supplier management of every manufacturing company. The generic information model is preferably tailored to a specific business process, a specific workflow and/or a specific company by types of data objects of the generic information model being deleted or modified. In particular, data objects of the generic information model that are not required for this business process and this company are deleted. If required, data objects are added. Data object types are modified for example by attributes being added or deleted or preferential or standard values being prescribed. However, the generic information model is so powerful that it is adequate for most applications of a category. Such a category is, for example, the supplier management of manufacturing companies described by a respective business process with workflows.

The generic information model comprises all data object types and relations which are required to describe the workflow for the supplier management of a manufacturing company. The generic information model consequently replicates the terminology of the process experts. It supports and facilitates full notation and modeling of the workflows, including all input and output variables and parameters of working steps. Because the terminology of the process experts is replicated, there is no need for a laborious and error-prone translation step between models and descriptions of the experts, and media breakdowns do not occur. This advantage is noticeable in particular in the case of subsequent changes and additions during the specification of workflows.

This way of producing the firm-specific information model 530 and the data model 531 derived from it requires substantially less expenditure in terms of time and costs than producing it “from scratch”. There is a reduction in the risk of significant semantic material being omitted from the information model that forms a basis for the data storage system 570 of the processing tool 560, and consequently under some circumstances also the specification 550 of the workflow. Rather, there is an increase in the probability of a complete information model being created.

The generic information model is preferably tailored in such a way that it is as compatible as possible with information models of productively used legacy systems, for example for goods management or production control. This allows these legacy systems to remain productive. They are integrated in the supplier management and the supplier manager not only on a data level but also on a logical level. The legacy systems can continue to be used; expensive reimplementation, for example of tried-and-tested legacy systems, is not necessary. Double data storage is not necessary. If required, such a legacy system acts as a source of data for the supplier manager or, conversely, “obtains” data from the supplier manager 560. This is made possible, inter alia, by the firm-specific information model 530.

FIG. 1 shows an example of a generic information model for the supplier management. In this example, data object types are represented by rectangles and relations between these data object types are represented by lines. The relations between data object types determine which relations between data objects of these types are permissible. A special relation between two data object types A and B is the included relation, which is identified by a lozenge. For example, the data object type 100.1 (“extents of procurement”) explained below is connected by such a relation to the data object type 100.2 (“partial extents of procurement”). An extent of procurement may include a number of partial extents of procurement; therefore, a data object for an extent of procurement may be connected by an included relation to a number of data objects for in each case a partial extent of procurement. The lozenges in FIG. 1 are located near the types of those data objects which may include other data objects. The relations between data object types are also provided with membership intervals 110, which indicate upper and lower limits as to how many data objects of these types may in each case be connected to one another by a relation. Such a membership interval has the form “a:b”, where a is a natural number or 0 and b is a natural number or “n” as a symbol for the absence of such a limit. Furthermore, specialization relations are depicted by an edge with an arrow at one end. The notation of FIG. 1 is based on the “Unified Modeling Language” (UML) as a known object-oriented means of description.

A preferred component part of the information model of FIG. 1 is the data object type 100.1 (“extents of procurement”). This type groups together all data objects which represent extents of procurement. An extent of procurement describes one or more subsystems or functional groups or subassemblies. Examples of extents of procurement are “shell”, “headlamp” and “driver's seat”.

A data object for an extent of procurement preferably runs through a complete workflow or even a number of workflows for the supplier management. At the beginning of this workflow, the extent of procurement is only broadly described in functional terms. Specific component types or material groups or even part numbers are not generally assigned to the extent of procurement at the beginning of the workflow. In particular, an extent of procurement differs in this way from a material group, which merely groups together specific, already determined component types.

The processing of a business process with a number of workflows for the supplier management is preferably already commenced at an early point in time of product development, at which determinations and decisions for specific component types have not yet been established. In the course of product development, the internal structure of a subsystem or functional group or subassembly is determined, computer-aided constructions are produced, and the corresponding objects, for example component types or material groups, are assigned to the extent of procurement in the business process for the supplier management. If required, the requisite manufacturing tools, software programs or services are also determined, specified in detail and assigned to the extent of procurement as corresponding data objects or attributes. At the end of the business process, the extent of procurement forms as it were an envelope, a “cocoon”, which has attributes and is connected by relations to a number of further data objects which determine the extent of procurement in detail. These further data objects are, for example, material groups, component types, delivery deadlines, prices, quality requirements, numbers of items, suppliers, manufacturing plants, required tools and software programs.

One of the reasons why the data object type for extents of procurement is provided in the information model is that one and the same extent of procurement runs through the entire electronic workflow or even the entire business process, and is thereby enriched by relations with other data objects and by attributes. The supplier manager preferably produces a data object for an extent of procurement at an early point in time and thereby makes possible efficient IT support for the early integration of suppliers. It is not necessary for the supplier manager to produce at an early point in time determinations which cannot then be established later. It is likewise not necessary to produce a data object with few determinations for early phases of the business process and a further data object with many determinations for later phases. This would lead to double data storage and possibly to inconsistent and contradictory data, in particular if changes are made later but not extended to all the data objects.

A data object of the data object type for extents of procurement makes it possible to allow an object that is relevant for the purchasing of the manufacturing company to run through a workflow without, for example, constructive refinements and determinations in the course of the product creation process leading to translation steps, media breakdowns or the like, and without information that is not yet available at the given point in time being inquired or even forcibly obtained.

The data objects of the type for extents of procurement make it possible to allow a variable that is relevant for purchasing to run through the workflow without, for example, constructive refinements and determinations in the course of the product creation process leading to translation steps, media breakdowns or the like, and without information that is not yet available at the given point in time being inquired or even forcibly obtained. Instead of this, an extent of procurement is enriched by information, for example on component types, as it runs through the workflow.

The generic information model additionally comprises, for example, the following types of data objects and relations between these types:
A data object for an extent of procurement may be directly in relation with the data objects which determine and describe the extent of procurement in detail, or else comprise a number of partial extents of procurement which for their part are connected by relations to the data objects for detailed determinations. A partial extent of procurement is the smallest data object for purchasing. A partial extent of procurement is preferably in a relation with precisely one supplier. The partial extent of procurement is connected by relations to all other data objects which describe the extent of procurement in detail and are used for obtaining the part of the extent of procurement originating from this one supplier. If the objects of an extent of procurement are obtained from a number of suppliers, at least one partial extent of procurement is produced for each supplier. It is possible to produce a number of extents of procurement for one supplier, for example if the supplier supplies to a number of production plants of the manufacturing company. The information model of FIG. 1 comprises a data object type 100.2 (“partial extents of procurement”), which is connected by an included relation to the data object type 100.1 (“extents of procurement”). An extent of procurement includes no, one or a number of partial extents of procurement in connected form, which is determined by the membership interval 110.1 with the value “0:n”. Conversely, a partial extent of procurement belongs to precisely one extent of procurement, which is determined by the membership interval 110.2 with the value “1:1”.
A product type identifies the type of product to which the extent of procurement relates. A product type comprises one or more extents of procurement. In the case of a car manufacturer, this product type is often identified by the type series (for example A class), the type of construction (for example sedan or coupe) and a functional group. The information model of FIG. 1 comprises a data object type 100.4 (“functional groups”), 100.5 (“type series”), 100.6 (“types of construction”) and 100.9 (“material groups”).
A quantity structure identifies the likely number of items of the product type. This number of items can be divided among various manufacturing plants by means of an allocating specification. This allocating specification preferably allows for the case where different subsystems or subassemblies of a product are manufactured in different manufacturing plants.
The product to which the supplier management relates is preferably described by a hierarchical product structure. This product structure preferably applies not only to a specific product type, for example a type series, but to a category of products, for example to each car of a specific segment. The product structure is, for example, a description of a hierarchical breakdown of the product in the form of a tree structure. The nodes of this tree structure stand for individual units under consideration of the product, for example for functional groups, subsystems, subassemblies, components. The root of the tree structure stands for the product as a whole, the leaves for components handled as elemental. For these units under consideration, a dedicated data object type 100.1 (“product types”) is introduced.
A component type is described by a dedicated data object. The information model of FIG. 1 comprises a data object type 100.10 (“component types”).
A material group is likewise described by a dedicated data object and identified by a unique material group code (“commodity code”). The material groups preferably form a tree-like relationship hierarchy (taxonomy), the leaves of which are component types that can be supplied. The material group code is hierarchically constructed. For example, the material group code comprises six digits, of which the first two digits designate the functional group and the next two digits designate the subassembly in which the component type is used. The component types of a subassembly are distinguished from one another by the last two digits. The data object with a material group may be connected by relations for example to an extent of procurement or a partial extent of procurement, with component types, with units under consideration and at least one set of suppliers. An extent of procurement or a partial extent of procurement may be connected by relations to one or more material groups. The information model of FIG. 1 comprises a data object type 100.9 and (“material groups”).
The generic information model allows for different variants of a component type or assembly, which is important specifically in the automobile industry with its great number of variants and complexity. Therefore, data objects are made possible for positioning variants and a data object type is provided for these in the information model.
A supplier is represented by a dedicated data object. The supplier may be assigned for example information on official certifications and approval decisions of the manufacturing company. The information model of FIG. 1 preferably comprises a data object type 100.3 (“suppliers”) for the suppliers that are in fact available and a further data object type 100.13 (“selected suppliers”) for the suppliers respectively selected for an extent of procurement or partial extent of procurement.
During the processing of a workflow for the supplier management, often one or more suppliers are selected for a prescribed extent of procurement. This extent of procurement relates to specific units under consideration and is connected to material groups and/or component types. A set of suppliers is often already prescribed for a material group, a unit under consideration or component type, and one or more are selected only from among these suppliers. Therefore, a dedicated class for sets of suppliers is provided in the information model. In a continuation, a distinction is made between two types of sets of suppliers, and therefore two classes of sets of suppliers are included in the information model. A prescribed strategic set of suppliers is a set of suppliers, for example for a material group, that are established in advance on the basis of fundamental determinations made by the company, the determination being valid for many extents of procurement. A provisionally selected set of suppliers comprises suppliers who were preselected for a specific extent of procurement at an early phase of the business process. Therefore, the information model comprises a data object type 100.11 (“strategic sets of suppliers”) and a further data object type 100.12 (“provisional sets of suppliers”).
A manufacturing plant is represented by a dedicated data object. This data object is connected by relations for example to data objects for extents of procurement or partial extents of procurement and also for units under consideration. The information model comprises a data object type 100.8 (“manufacturing plants”).
To be able to assign responsibilities to the working steps in the specification 550 of the workflow, a data object type 100.16 (“persons responsible”) is adopted for the responsibilities. The data object for a responsibility may be connected by relations for example to a data object for an extent of procurement, for a unit under consideration or a material group.
All the documents for inquiries and invitations to tender that are sent for a specific extent of procurement or partial extent of procurement are managed in dedicated data objects which have references to these documents and to management information of the documents. For these data objects, a dedicated data object type 100.17 for “inquiries” is provided in the information model. The data objects of this data object type are connected by relations to extents of procurement or two partial extents of procurement and to the respectively selected suppliers.
By analogy, all the offers for a specific extent of procurement or partial extent of procurement are managed in a dedicated data object. A dedicated data object type for “offers” is also provided in the information model for these data objects. The data objects of this data object type 100.15 are connected by relations to extents of procurement or to partial extents of procurement and also to the respectively selected suppliers.

Both the generic information model and the firm-specific information model 530 are independent of a specific physical data storage scheme, for example a specific databank scheme. In particular for this reason, the information model is independent of a specific IT environment in which the supplier manager is used. Various data models, and thereby various data storage schemes, can be derived from the same information model, for example databank schemes for relational or object-oriented databanks. For example, a relational databank can be substituted by another relational databank or an object-oriented databank without the firm-specific information model 530 or the specification 550 of the workflow or business rules having to be changed.

The generic information model comprises all data objects and relations which are required to specify the workflow or workflows for the supplier management of a manufacturing company. The generic information model consequently replicates the terminology of the process experts. It supports and facilitates full notation and specification of a workflow, including all input and output variables and parameters of working steps. Because the terminology of the process experts is replicated, there is no need for a laborious and error-prone translation step between specifications and descriptions of the experts and a descriptive language that can be used in IT areas, and media breakdowns do not occur. This advantage is noticeable in particular in the case of subsequent changes and additions during the specification of workflows. The data model that is best suited in each case can be used with the best-suited information-technology descriptive language, for example “entity-relationship diagrams” (ER diagrams) or the “Unified Modeling Language” (UML).

The business process is described by an electronically available specification 550. This specification is produced and stored by a facility 580 for specifying a workflow. This facility is referred to hereafter as the specifying facility. The specifying facility 580 preferably comprises a second data processing system.

The specification 550 produced by the specifying facility 580 describes, for example, all workflows which arise in supplier management. The specification 550 is tailored to the requirements and circumstances of a manufacturing company, for example to the supplier management of an automobile manufacturer. Used with preference in the specification 550 are those data objects and relations between data objects that belong to data object types or relations between data object types of the firm-specific information model 530.

A workflow is preferably specified with the aid of a directed graph with nodes and edges. The “inputs” of a node K are then the edges of the predecessors of the node K with respect to the node K, the “outputs” are the edges of K with respect to its successors. A detail of an electronic specification 550 of a workflow is shown by way of example in FIG. 2. This graph has at least the following types of nodes:
event nodes 200.1, 200.2, . . . , for example “extent of procurement determined” or “strategy for order-placement process determined” or “set of suppliers for order-placement process determined”. The event nodes also include the start event nodes, which have no predecessor and at least one successor and act as entry points of a workflow, and target event nodes, which have no successors and at least one predecessor,
functional nodes 210.1, 210.2, . . . , for example “check order” or “change deadlines”, which have at least one predecessor and at least one successor, determine working steps of a workflow and are preferably described by activities,
data object nodes 220.1, 220.2, . . . , for example data objects for “partial extent of procurement” or “supplier”, which stand for an information flow into or from the workflow, for example a reading or writing access to a databank, which have at least one predecessor or at least one successor and which are of a data object type of the firm-specific information model 530,
organizational unit nodes 240.1, 240.2, . . . , for example “product project leader” or “specialist purchaser”, which determine who is responsible for carrying out a working step. Generally, an organizational unit node is assigned to a functional node, for example by an edge for an organizational flow; the supplier manager may also be responsible instead of a natural person,
process variable nodes 240.1, 240.2, . . . , for example “status of order-placement process”. A process variable node is connected to the event nodes of which the event comprises that the process variable concerned assumes a specific value. For example, a process variable node “status of order-placement process” is connected to the event node “set of suppliers for order-placement process determined”. The same or further “status of order-placement process” process variable nodes are connected to other event nodes of which the event relates to the respectively achieved status of the workflow, for example the order-placement process,
AND connecting nodes 410.1 with a number of predecessors and one successor, which influences the processing of a workflow. If all the predecessors, which are event nodes, are satisfied and/or the successors, which are functional nodes, are executed, a skip is made to the successor of the AND connecting node. For example, an AND connecting node 410.1 has the predecessors “change order-placement deadline scheduling” and “change of deadline noted” and the successor “accept new deadline”,
OR connecting nodes 400.1 with a number of predecessors and one successor, which likewise influences the processing. If at least one predecessor is satisfied or executed, a skip is made to the successor. For example, an OR connecting node has the predecessors “add potential suppliers”, “delete potential suppliers” and “confirm potential suppliers” and the successor “potential suppliers determined”,
X-OR branching nodes 420.1 (“exclusive or”) with a number of predecessors and one successor. If precisely one predecessor is satisfied or executed, a skip is made to a successor. A branching condition determines under what condition a skip is made to a successor. For example, an X-OR writing node 420.1 has the predecessors “order-placement documentation formulated” (an event node) and “revise order-placement documentation” (a functional node) and the successor “approve order placement”,
AND branching nodes with one predecessor and a number of successors. If the predecessor is satisfied or executed, a skip is made to all the successors,
OR branching nodes 430.1 with one predecessor and a number of successors. If the predecessor is satisfied or executed, a skip is made to at least one successor,
X-OR branching nodes (“exclusive or”) with one predecessor and a number of successors. If the predecessor is satisfied or executed, a skip is made to precisely one successor. A branching condition determines under what condition a skip is made to which successor. For example, an X-OR branching node has the predecessor “obtain agreement on potential suppliers” and the successors “all agreements obtained” and “clear potential suppliers”.

A solid arrow in FIG. 2 stands for a functional flow 310.1, 310.2, . . . , for example from a data object node, a broken arrow stands for an information service flow 300.1, 300.2, . . . , a solid line for an organizational flow 320.1, 320.2, . . .

The electronic specification 550 of the workflow is preferably hierarchically constructed in the sense that an individual complex working step of a coarse granularity is written by a partial business process of a finer granularity. As described above, inputs, outputs, responsibilities (Which roles? Who?) and statements on deadlines and execution times are determined for each working step of the business process.

The workflow often additionally includes master data management.

A preferred embodiment of the device 600 according to the invention is shown in FIG. 3. Solid arrows stand in FIG. 3 for information flows during the production of the processing tool. Broken arrows stand for information flows during the work of the processing tool.

Standard information models are stored in an electronic library 510.

The facility 520 for producing a firm-specific information model 530 comprises
means for selecting a standard information model of the library 510,
means for adding, deleting or changing data object types of the selected standard information model
and means for adding, deleting or changing relations between these data object types.

With the aid of the producing facility 520, the firm-specific information model 530 is produced.

The specifying facility 580 has reading access to this firm-specific information model 530 and to an electronic library 540 with preconfigured specifications of standard workflows. Each specification of a standard workflow is assigned a standard processing tool from a further electronic library 590. The specifying facility 580 comprises means for selecting one of the standard workflows. It produces the specification 550 of the workflow.

A configuring facility 500 has reading access to the further electronic library 590 with standard processing tools and to the specification 550. The configuring facility 500 configures that standard processing tool of the library 590 which is assigned to the selected standard workflow. For this, the configuring facility 500 uses the specification 550. The configured standard processing tool is able to process the workflow specified by the specification 550.

Calculating and checking rules link data objects of specific types described by the information model 530 to one another. Further rules relate to working steps or events of the business process or link data objects with working steps or events. Rules of this type are sometimes also known as business rules. A checking rule checks for example working steps or data objects produced during the processing for integrity and consistency (freedom from contradiction) and completeness. For example, such a checking rule ensures that each data object for a partial extent of procurement is in precisely one of three possible states, or the working step “partial extent of procurement” is in precisely one of five possible states during the entire processing. Other rules carry out calculations, for example by determining an invoice amount with value-added tax and the like as a sum of the individual items, calculate gross/net effects or determine the actual anticipated value from cost items. Business rules and their application for work processes are known for example from WO 01/13303 A1.

The calculating and checking rules for a supplier manager are preferably produced by rules being selected from a prescribed library with standard rules and the selected rules adapted if required. The adaptation is necessary for example to adapt the rules to the firm-specific information model 530, the specification 550 of the workflow or to other firm-specific circumstances. The other circumstances may include a firm-specific product data structure, for example a specific layout of parts lists or product documentation.

In order to produce the firm-specific information model 530 and the specification 550 of the workflow to be processed for the manufacturing company, the following procedure is applied for example:
IBZED matrices are created. These define information, involvement, agreement, decision-making, implementation.
The firm-specific information model 530 is created as described above. From this, a data model 531 is derived. Preferably, an object-oriented descriptive language, for example the Unified Modeling Language (UML), is used for the data model 531. The UML model comprises use cases, class diagrams and activity diagrams. It contributes, inter alia, to the specification of the user interface. The data model determines a data storage scheme.
With a software tool 580, a specification 550 of the workflow or the workflows is produced. Software tools of this type are known in principle, for example from A.-W. Scheer, loc. cit., and WO 02/19224 A1. According to the invention, the firm-specific information model 530 is used for this.
Objects and relationships which cannot be expressed by the software tool 550 used for the modeling are supplemented for example by calculating and/or checking rules.
If required, the specification 550 of the workflow is supplemented by textual descriptions. These descriptions are assigned in particular to individual working steps or complete workflows. At least one form template is used for this; this is completed for example by a word processing system. If required, descriptions are added in free text.

For these steps, IT support for persons to work together (“groupware”) is additionally used, for example group interaction software, discussion databanks, a conference system and e-mail.

An IBZED matrix comprises a sequence of working steps to be executed by the supplier management one after the other and/or in parallel. Each working step is preferably identified by an activity, for example “initiate order-placement process”. Furthermore, the following information is determined for example for each working step:
the individual activities comprising the working step, for example “determine partial extent of procurement”, “preselect set of suppliers” and “accept preselected set of suppliers”,
the prerequisites for the working step, in particular the complete execution of specific other working steps, the results of which are required, for example “accept order-placement strategy”,
the events which the working step produces after complete execution, for example “order-placement process as task has arrived in the electronic intray of specialist purchaser and functional group spokesman”,
the responsibilities, for example which organizational unit and incumbents of which roles, are involved and how, and comments.

In what way an organizational unit or an incumbent of a role is involved is identified by one of the five determinations, viz. information, involvement, agreement, decision-making, implementation.

It is possible to produce the specification 550 of the workflow “from scratch”. On the other hand, work and time are saved, and the risk of errors is reduced, if instead of this preconfigured specifications of standard workflows from a library 540 are used (“workflow customizing”). These selected workflows are then parameterized and adapted. This procedure requires much less expenditure than, for example, in the case of “customizing” a workflow management system which does not have standard workflows for the supplier management, or even an individual implementation or specification “from scratch”.

The specifications of the standard workflows are preferably described with the aid of the data object types, attributes and relations of the generic information model and the node types described above for workflow specifications. The firm-specific workflows are specified correspondingly with the aid of the data object types, attributes and relations of the firm-specific information model 530. Furthermore, the workflows comprise data-technical data objects, which for example control the implementation of the workflow including resetting, or ensure with the aid of the data storage system 570 persistent data storage and multiuser operation without access and data conflicts.

The library 540 preferably comprises the following standard workflows for the supplier management:
determination of strategies or prescribed specifications for order-placement decisions for a prescribed extent of procurement to at least one supplier,
order placement of a predetermined extent of procurement to at least one supplier (order-placement process),
handling of changes to at least one prescribed extent of procurement,
recording and/or assessment of at least one supplier,
monitoring of the procurement operation for a prescribed extent of procurement and
cost reduction for a prescribed extent of procurement,
forming of the cost target for at least one prescribed extent of procurement,
forming of the cost target for at least one cost type which is associated with at least one prescribed extent of procurement.

By way of example, the electronic workflow for the order-placement process is described. At least one extent of procurement or partial extent of procurement is prescribed. The type of order placement has been determined for each prescribed extent of procurement and partial extent of procurement. Possible types of order placement are the direct placement of an order with a supplier, classic invitation to tender and concept competition.

After completion of the order-placement process, the following desired results are achieved:
The potential suppliers for each extent of procurement or partial extent of procurement are preselected. For this purpose, a preselection is made from among the suppliers accepted in principle for the extent of procurement or partial extent of procurement. The final selection is later carried out from among these suppliers.
Deadlines for component specification booklets which specify the component types to be supplied are determined.
Inquiries are sent to the potential suppliers.
The offers received in response are collected and can be managed by means of an “offers” data object.
The standard documents for contract formation are available.
The order-placement documentation is generated.

At least one standard workflow from the library 540 is selected. The selected standard workflow is adapted if required to the firm-specific information model 530.

In the production of the specification 550, the selected standard workflow is adapted to the workflow to be processed. If required, working steps of the standard workflow are thereby added, deleted or changed.

Each electronic standard workflow from the library 540 is assigned a standard processing tool. It is possible for different standard workflows to be assigned the same standard processing tool. The standard processing tools are stored in a library 590. Each of the standard processing tools is linked with a data storage system, for example a relational databank. Different standard processing tools may be linked with the same data storage system. It is also possible that all the standard workflows are assigned the same standard processing tool or all the standard processing tools are connected to the same data storage system.

The standard processing tool of the selected standard workflow is configured by means of the specification 550 of the workflow to be processed. The data storage system 570 of the processing tool 560 is configured with the firm-specific information model 530 and the data model 531 derived from it.

The software architecture of the supplier manager 560 preferably comprises three layers that are logically separate from one another:
the user interface layer 562 of the user interface with screen forms,
the application layer 561 with control of the processing on the basis of the application logic and control of the user interface and the application of rules
and the data storage layer 563 with the data storage system 570.

The three levels are separated from one another in such a way that they interact exclusively via defined interfaces. As a result, a software tool, for example a data store or a component of the user interface, can be exchanged without the other component parts of the supplier manager having to be adapted.

Because the layer 562 of the user interface is separate from the application layer 561, it can easily be adapted to a prescribed standard for the screen design and the user prompting (“style guide”). Changes of the application layer or even data storage layer 563 are not required.

Internet technologies are preferably used. The users of the supplier manager have access via a company intranet or the Internet to the supplier manager. An Internet access program (“Web browser”) on a network user computer (“client”) is preferably sufficient for the reading and writing access, so that no or only few components of the supplier manager or data objects for the supplier manager need be stored on the network user computer. Rather, data are stored and kept available in a data storage system 570, for example a relational databank, on at least one central network computer (server). The data storage system 570 ensures that only one user has writing access to a data object at a point in time, in order that data integrity remains ensured.

The device 600 according to the invention is likewise preferably realized with the aid of a multilayer architecture. Architectures of this type are known for example from A.-W. Scheer, loc. cit. The ARIS software tool (“framework”) disclosed there has an architecture with the following four layers:
the layer of process formation, which comprises tools to model a business process. A user can produce process, function and data models, organigrams and diagrams for authorizations,
the layer of process planning and control, which comprises tools with which the processing of a business process is controlled and monitored, for example the “ARIS Process Control Interface” and tools for cost calculations which are related to working steps and activities (“ARIS Activity-Based Costing”),
the layer of workflow management for the processing of workflows and with interfaces to workflow management systems,
the layer of business objects (“ARIS Business Objects”). Examples of business objects are customer, order, work schedule, working operation, supplier.

The device 600 according to the invention can be realized for example on the basis of a development environment by the name of Versata. This is disclosed for example at http://www.versata.com or http://www.versata-deutschland.de/, visited on Feb. 20, 2002. Versata produces the business logic and the associated change and management processes on the basis of the firm-specific business rules with the aid of the “Business Logic Automation”.

The supplier manager 560 produced according to the invention preferably has interfaces to legacy systems which belong to the IT environment in which the supplier manager is being used, and these continue to be used. These legacy systems include, for example, a merchandise management system, a production planning and control system (“enterprise resource management system”), a system for customer care and customer orders (“customer relationship management system”), a product data management system (“engineering data management system”) and a “document management system”.

To sum up, the invention relates to a device 600, a method and a computer program product for producing a processing tool which processes an electronic workflow comprising working steps and comprises an application layer 561 and a data storage system 570. The firm-specific information model 530 with types of data objects is produced by adapting a standard information model, for example for supplier management. This firm-specific information model 530 is used to produce a specific data model 531 as a physical data storage scheme. On the basis of this data model 531, the data storage system 570 is produced. The specification 550 of the workflow to be processed is produced by selecting a standard workflow from a library 540 and adapting it to the workflow, and if required to the firm-specific information model 530. Linked with the selected standard workflow is a standard processing tool from a further library 590, which is configured by means of the specification 550. The invention makes it possible to produce processing tools quickly and efficiently and to integrate legacy systems not only on a data level but also on a logical level.

List of designations

| Designation | Meaning |
|---|---|
| 100.1, 100.2, . . . | data object types |
| 100.1 | data object type for extents of procurement |
| 100.2 | data object type for partial extents of procurement |
| 100.3 | data object type for suppliers |
| 100.4 | data object type for functional groups |
| 100.5 | data object type for type series |
| 100.6 | data object type for types of construction |
| 100.7 | data object type for product types |
| 100.8 | data object type for manufacturing plants |
| 100.9 | data object type for material groups |
| 100.10 | data object type for component types |
| 100.11 | data object type for strategic sets of suppliers |
| 100.12 | data object type for provisional sets of suppliers |
| 100.13 | data object type for selected suppliers |
| 100.14 | data object type for quantity structures |
| 100.15 | data object type for offers |
| 100.16 | data object type for persons responsible |
| 110.17 | data object type for inquiries and invitations to tender |
| 110.1, 110.2 | membership intervals |
| 200.1, 200.2, . . . | event nodes |
| 210.1, 210.2, . . . | function nodes |
| 220.1, 220.2, . . . | data object nodes |
| 240.1, 240.2, . . . | organizational unit nodes |
| 240.1, 240.2, . . . | process variable nodes |
| 300.1, 300.2, . . . | information service flow |
| 310.1, 310.2, . . . | functional flow |
| 320.1, 320.2, . . . | organizational flow |
| 400.1 | OR connecting node |
| 410.1 | AND connecting node |
| 420.1 | X-OR branching node |
| 430.1 | OR branching node |
| 500 | facility for configuring a selected standard processing |
| | tool (configuring facility) |
| 510 | library with standard information models |
| 520 | information model producer |
| 530 | firm-specific information model |
| 531 | data model of the data storage system of the |
| | processing tool |
| 540 | library with standard workflows |
| 550 | specification of the workflow |
| 560 | processing tool |
| 561 | application layer of the processing tool |
| 562 | user interface layer of the processing tool |
| 563 | data storage layer |
| 570 | data storage system of the processing tool |
| 580 | facility for specifying the workflow (specifying |
| | facility) |
| 590 | library with standard processing tools |
| 600 | device according to the invention |
| 610 | facility for producing a databank scheme from an |
| | information model |

1-15. (canceled)

16. A device for producing a processing tool arranged and configured to process at least one electronic workflow comprising working steps on a first data processing system, the device comprising:
a facility for producing an information model, the information model including data object types and relations between the data object types;
a specifying facility for producing an electronic specification of a workflow, utilizing the information model;
a configuring facility for configuring a prescribed standard processing tool as a function of the specification, the prescribed standard processing tool including a prescribed data storage system; and
an adapting facility for adapting the prescribed data storage system to the information model;
wherein the facility for producing the information model is arranged and configured for executing an operation for adding, deleting or changing data object types of a prescribed information model; and for executing an operation for adding, deleting or changing relations between the data object types;
wherein the configuring facility is arranged and configured for executing an operation for selecting, adding, deleting, changing or linking working steps; for executing an operation for selecting a data object type of the information model and producing a data object of a selected data object type; and for executing an operation for linking data objects with working steps.

17. The device of claim 16, further comprising a library with electronic standard workflows, each electronic standard workflow being assigned a standard processing tool, and, wherein
the specifying facility is arranged and configured to execute an operation for selecting a standard workflow from the library and executing an operation for working on the selected standard workflow,
the configuring facility being arranged and configured for executing an operation for configuring a standard processing tool assigned to the selected standard workflow.

18. The device of claim 17 wherein the library comprises at least one of electronic standard workflow for a supply management of a company manufacturing technical products, selected from the group consisting of:
determination of strategies or prescribed specifications for order-placement decisions for a prescribed extent of procurement to at least one supplier,
order placement of a predetermined extent of procurement to at least one supplier,
handling of changes to at least one prescribed extent of procurement,
recording or assessment of at least one supplier,
monitoring of a procurement operation for a prescribed extent of procurement,
cost reduction for a prescribed extent of procurement,
forming of a cost target for at least one prescribed extent of procurement, and
forming of a cost target for at least one cost type associated with at least one prescribed extent of procurement.

19. The device of claim 16 wherein the information model comprises
a data object type for component types,
a data object type for suppliers
and a data object type for extents of procurement, and
wherein the data object type for extents of procurement is connected by a respective relation to the data object type for component types and the data object type for suppliers.

20. The device of claim 19 further comprising a facility for producing a data object generator and for integrating the generator in the processing tool
and the data object generator being arranged and configured to generate a first data object of the data object type for extents of procurement and data objects of the data object type for suppliers and of the data object type for component types,
the first data object being arranged and configured for connectability to the data objects by relations during an entire processing of the electronic workflow.

21. The device of claim 20 wherein the information model comprises a data object type for partial extents of procurement, connected by a relation to the data object type for suppliers, and
wherein each data object of the data object type for partial extents of procurement being arranged and configured for connectability to at most one data object of the data object type for suppliers during processing.

22. The device of claim 16, further comprising a library of standard business rules which relate to data object types and working steps, and a facility for selecting standard business rules.

23. The device of claim 16 wherein the facility for producing the information model further comprises a facility for producing a data model compatible with the information model by using the Unified Modelling Language.

24. A method for producing a processing tool, the processing tool processing at least one electronic workflow comprising working steps on a first data processing system, and a second data processing system being used for producing the processing tool, the method comprising the steps of:
producing an information model for the workflow, the step of producing being carried out by adapting a prescribed information model and, during the adaptation, executing an operation for adding deleting or changing data object types and relations between data object types,
producing a specification of the workflow by using data object types and relations of the adapted information model,
adapting a standard processing tool comprising a prescribed data storage system to the adapted information model,
adapting the prescribed data storage system to the adapted information model, and
configuring the adapted standard processing tool as a function of the specification.

25. The method of claim 24 comprising the further steps of:
selecting at least one electronic workflow from a library of electronic standard workflows with working steps, each electronic standard workflow being assigned a standard processing tool,
assigning the adapted standard processing tool to the selected standard workflow, and
in the production of the specification, adapting the selected standard workflow to the workflow to be processed to thereby modify the working steps of the standard workflow.

26. The method of claim 24 comprising the further step of producing a source program for the processing tool, the source program being executable after translation into a machine language on the first data processing system.

27. The method of claim 24, comprising the further step of:
by analysis of the processing tool produced, determining working steps of the electronic workflow having influence on a processing time of the processing tool.

28. The method of claim 24 comprising the further steps of:
producing a second processing tool for processing a further electronic workflow,
determining for each of the processing tool and the second processing tool average numbers of generated screen forms, of required screen interactions, of databank reading accesses and of databank writing accesses, and
producing a comparison of a workflow and a second further workflow in respect of the average numbers.

29. A computer program which can be loaded directly into the internal memory of a computer and comprises software modules with which a method for producing a processing tool is executed, the processing tool processing at least one electronic workflow comprising working steps on a first data processing system, and a second data processing system being used for producing the processing tool, the method can be executed when the program runs on a computer, the method comprising the steps of:
producing an information model for the workflow, the step of producing being carried out by adapting a prescribed information model and, during the adaptation, executing an operation for adding deleting or changing data object types and relations between data object types,
producing a specification of the workflow by using data object types and relations of the adapted information model,
adapting a standard processing tool comprising a prescribed data storage system to the adapted information model,
adapting the prescribed data storage system to the adapted information model, and
configuring the adapted standard processing tool as a function of the specification.

30. A computer program product which is stored on a medium which can be read by a computer and which has program modules which can be read by a computer and cause the computer to execute a method for producing a processing tool, the processing tool processing at least one electronic workflow comprising working steps on a first data processing system, and a second data processing system being used for producing the processing tool, the method comprising the steps of:
producing an information model for the workflow, the step of producing being carried out by adapting a prescribed information model and, during the adaptation, executing an operation for adding deleting or changing data object types and relations between data object types,
producing a specification of the workflow by using data object types and relations of the adapted information model,
adapting a standard processing tool comprising a prescribed data storage system to the adapted information model,
adapting the prescribed data storage system to the adapted information model, and
configuring the adapted standard processing tool as a function of the specification.
